(19) United States
(12) Patent Application Publication
(10) Pub. No.: US 2005/0284699 A1
(43) Pub. Date: Dec. 29, 2005

(54) Bilateral ladder handles

(76) Inventor: Nancy Fowler, Conyers, GA (US)

Correspondence Address: HILL, KERTSCHER & PIXLEY LLP, 3350 RIVERWOOD PARKWAY, SUITE 800, ATLANTA, GA, 30339, US

(21) Appl. No.: 10/877,699

(22) Filed: Jun. 25, 2004

(51) Int. Cl. E06C 7/18

(52) U.S. Cl. 182/106

(57) ABSTRACT

This invention relates to all ladders, specifically those for non-commercial use, although this invention can be applied to all types of ladders. Bilateral handles will provide the user with added support while climbing up the steps of the ladder and while descending down the steps of the ladder. Being able to use both the right and left hands at the same time provides for a wider base of support and balance while climbing. The benefits clearly provide the user with a sense of well-being over other ladders.

### CROSS REFERENCE TO RELATED APPLICATION

None

### BACKGROUND OF THE INVENTION

This invention relates to all ladders, specifically those for non-commercial use, although this invention can be applied to all types of ladders. Bilateral handles will provide the user with added support while climbing up the steps of the ladder and while descending down the steps of the ladder. The user will be more comfortable and the bilateral ladder handles provide the user with greater emotional feeling of security, balance, control and safety while using both hands. Being able to use both the right and left hands at the same time provides for a wider base of support and balance while climbing. The benefits clearly provide the user with a sense of well-being over other ladders.

### SUMMARY OF THE INVENTION

The invention is essentially two (bilateral) handles, one on each side of a ladder, either structurally integral to the ladder, or handles that can be attached to any ladder.

### BRIEF DESCRIPTION OF THE DRAWINGS

FIG. 1 is a side view of an example ladder with the bilateral handles structurally integral to the ladder.

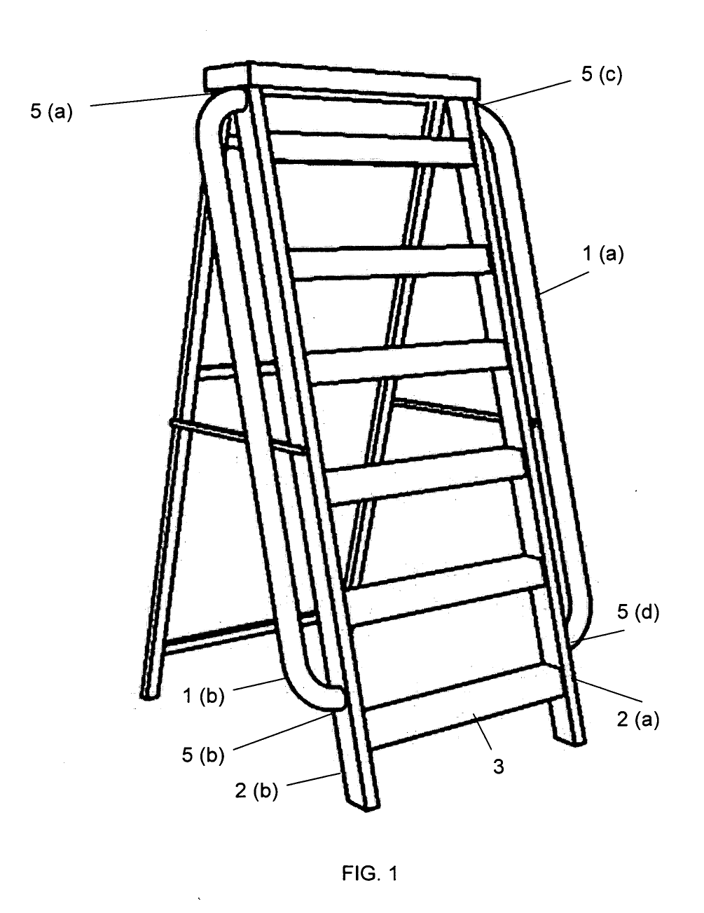

FIG. 2 is a side view of an example bilateral handle which will be attached to a ladder.

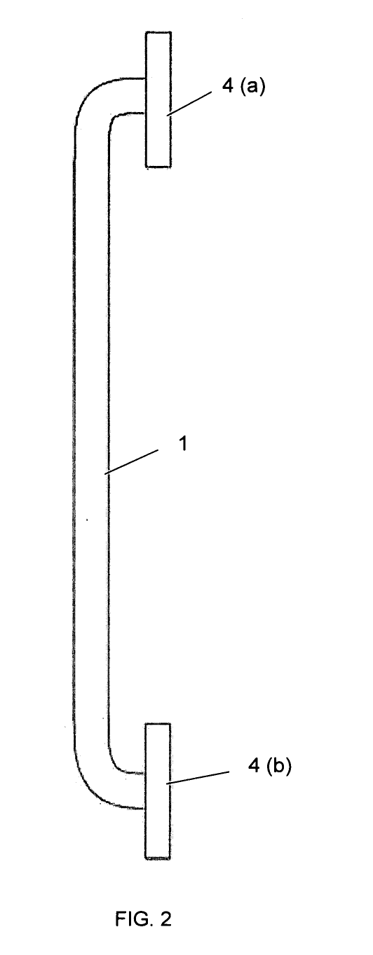

### DETAILED DESCRIPTION OF THE PREFERRED EMBODIMENT

This invention is directed towards parallel bilateral ladder handles 1. In one embodiment of the invention, the bilateral ladder handles 1 will be made as part of the original framework of the ladder 2. In another embodiment of the invention, the bilateral ladder handles 1 will be a separate after purchase product, capable of being attached to any ladder 2.

In the embodiment in which the bilateral ladder handles 1 are integral parts of the ladder 2, the bilateral ladder handles 1 may be manufactured of the same material of the ladder 2, such as plastic, metal or wood, or can be made using a different material, depending on manufacturer capabilities. The choice of material will be directed by consumer or manufacturer needs. The bilateral ladder handles 1 may have an added coating-covering type material over the bilateral ladder handles 1 or can have a smooth surface or a textured surface.

The bilateral ladder handles 1 are attached to the frame of the ladder 2 on both right and left sides of the ladder steps 3. The bilateral ladder handles 1 will be molded carved or soldered as part of the original frame of the ladder 2. The bilateral ladder handles 1 on the right and left side of the frame of the ladder 2 extend outward from the top of the ladder 2 frame, from each side (5(a), 5(c)), curving or bending downward towards the base of the ladder 2, finally reaching the distal end of the ladder 2 frame, and reinserting into the frame there (5(b), 5(d)).

In a second embodiment of the invention, the bilateral ladder handles 1 are sold as a separate item. These bilateral ladder handles 1 are capable of being attached to any ladder 2. The attachment means may be accomplished according to any manufacturer needs. The preferred embodiment of an attachment means will be through the use of holes drilled into the ladder frame 2, matched by holes drilled into the bilateral ladder handles 1 at each end of bilateral ladder handles 1 at points 4(a) and 4(b). Commercially available nuts and bolts will then be used to attach the bilateral ladder handles 1 to the ladder frame 2 at points 5(a), 5(b), 5(c) and 5(d). The bilateral ladder handles 1 may be manufactured of the same or different material from the ladder 2. The bilateral ladder handles 1 may have an added coating covering type material over the handles or can have a smooth surface or a textured surface, all depending on consumer or manufacturer needs. The bilateral ladder handles 1 will vary in size, shape, and length according to the height, type, and size of the ladder 2 it is put on.

As will be apparent to one of skill in the art, there are modifications to the preferred embodiment that are within the spirit and scope of this invention. It is the intention of the inventor to cover all such modifications.

1. A ladder comprising:
parallel support structures, between which are positioned rungs for climbing,
a first bilateral handle, protruding from the left support structure, said protrusion beginning to bend at least 1 inch extended from the left support structure,
said first bilateral handle extending parallel to the left support structure
said first bilateral handle bending back toward the support structure at the base of said support structure and reentering said support structure at said base, and
a second bilateral handle, protruding from the right support structure, said protrusion beginning to bend at least 1 inch extended from the right support structure,
said second bilateral handle extending parallel to the right support structure
said second bilateral handle bending back toward the right support structure at the base of said support structure and reentering said support structure at said base.

2. The ladder of claim 1 wherein said bend is a right angle to the length of the bilateral ladder handle.

3. The ladder of claim 1 wherein said bend is a curve.

4. The ladder of claim 1 wherein the entire structure is made of wood.

5. The ladder of claim 1 wherein the entire structure is made of plastic.

6. The ladder of claim 1, wherein the entire structure is made of metal.

7. The ladder of claim 1 wherein the support and rung structures are made of a different material than that of the bilateral handles, each being made of wood, plastic, metal or any other suitable material.

8. Independent bilateral ladder handles which may be attached to any ladder, comprising
first and second handles, with bends at their distal ends,
means for attaching said ladder handles to any ladder.

9. The bilateral ladder handles of claim 8, wherein the handles are made of plastic.

10. The bilateral ladder handles of claim 8, wherein the handles are made of metal.

11. The bilateral ladder handles of claim 8, wherein the handles are made of wood.

12. The bilateral ladder handles of claim 8, wherein the bend at each distal end of the length of each of the handles is at a right angle to the length of the handle.

13. The bilateral ladder handles of claim 8, wherein the bend at each distal end of the length of each of the handles curves such that said attachment means would meet the parallel support structures of the ladder on which the bilateral ladder handles would be disposed.

14. The bilateral ladder handles of claim 8, wherein the distal end of the length of each of the handles is attached to the ladder using any number of commercially available nuts and bolts.

15. The bilateral ladder handles of claim 8, wherein the distal end of the length of each of the handles is attached to the ladder using any means.
